(19) United States
(12) Patent Application Publication
(10) Pub. No.: US 2018/0238367 A1
(43) Pub. Date: Aug. 23, 2018

(54) Wedge Anchor Setting Tool and Method

(71) Applicant: Brian M. Laue, Cream Ridge, NJ (US)

(72) Inventor: Brian M. Laue, Cream Ridge, NJ (US)

(21) Appl. No.: 15/440,050

(22) Filed: Feb. 23, 2017

(51) Int. Cl. F16B 13/08; B28D 1/14

(52) U.S. Cl. CPC F16B 13/0891; B28D 1/146

(57) ABSTRACT

A wedge anchor setting tool has a drill bit component having a drill tool receiving member and a drill bit member. A polygonal shaped element is located between the two members. A sheath component has an open passage and an opening at the terminus of each end. The first end has a polygonal shape which conforms to the polygonal element and the second end having a polygonal shape which conforms to the shape of the wedge anchor. The method of installation using the tool includes drilling a channel into a wall using the drill bit component. The sheath component is then inserted over the drill bit component and a wedge anchor is inserted into the smaller opening at the second end of the sheath component. The wedge anchor is then drilled into the wall and tightened by the drilling tool to secure an attachment member to the wall.

### FIELD OF THE INVENTION

This invention relates to a setting tool and method for the installation of a wedge anchor into masonry and similar solid wall structures.

### BACKGROUND OF THE INVENTION

Wedge type anchors have long been installed into masonry walls and other solid structures which are fabricated of concrete, concrete brick, and similar materials, in order to fasten various different components to the structures. In most cases the anchors are hammered or otherwise installed into the holes, which are drilled by some type of rotary drilling tool. This is a laborious task, requiring excess manpower and time.

In order to address some of these disadvantages inherent in the installation of wedge anchors, various types of anchor setting tools have been proposed. While such tools purport to assist in the process of installing anchors into masonry structures, these tools have distinct disadvantages. Most setting tools consist of a number of separate components, requiring multiple installation steps. Others require additional tools, e.g. hammers, to complete the installation process. This results in the work being labor intensive and, in many cases, unsafe. This is especially true when anchors are to be installed in high or overhead locations.

None of the prior wedge anchor setting tools and methods provide a simple, easy to use, and effective installation tool.

### SUMMARY OF THE INVENTION

It is thus the object of the present invention to provide a wedge anchor setting tool and installation method which overcomes the disadvantages and limitations of existing anchor installation tools and installation methods.

It is the object of the present invention to provide a wedge anchor setting tool and installation method which consists of only two integral, separate, components which, along with a common rotary drilling tool, are easy to use.

It is another object of the present invention to provide a wedge anchor setting tool and installation method which can be configured to install a variety of differently sized wedge anchors.

It is a further object of the present invention to provide a wedge anchor setting tool and installation method which is safe to use in all wedge anchor installation locations and situations.

It is still another object of the present invention to provide a wedge anchor setting tool and installation method which provides an effective and accurate fit for the installation of wedge anchors.

It is another object of the present invention to provide a wedge anchor setting tool and installation method which requires the user to expend less labor and energy during the installation process.

These and other objects are accomplished by the present invention, a wedge anchor setting tool which comprises an elongated drill bit component having a drill tool receiving member its rear section and a drill bit member at its front section. A polygonal shaped element is located between the two sections. A separate and independent sheath component is provided which has an open passage and an opening at the terminus of each end, the first end having a polygonal shape which conforms to the polygonal element and the second end having a polygonal shape which conforms to the shape of the wedge anchor to be installed. The method of installing the wedge anchor with the setting tool includes drilling a channel opening into a solid wall or similar structure using the drill bit component. The sheath component is then inserted over the drill bit component and the wedge anchor is inserted into the smaller opening at the second end of the sheath component. The wedge anchor is then driven into the solid structure and tightened by the drilling tool to secure an attachment member to the wall.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the drill bit component of the present invention.

FIG. 2 is an isometric view of the sheath component of the present invention.

FIG. 3 is a reverse isometric view of the sheath component shown in FIG. 2.

FIG. 4 is an end view of the sheath component of the present invention.

FIG. 5 is the opposite end view of the sheath component of the present invention.

FIG. 6 is a representation of the initial drilling step of the method of the present invention.

FIG. 7 is a representation of the next step in the method.

FIG. 8 is a representation of the step of tightening a wedge anchor into a masonry structure.

FIG. 9 is an exploded view of the components of the present invention and the manner of their alignment for use.

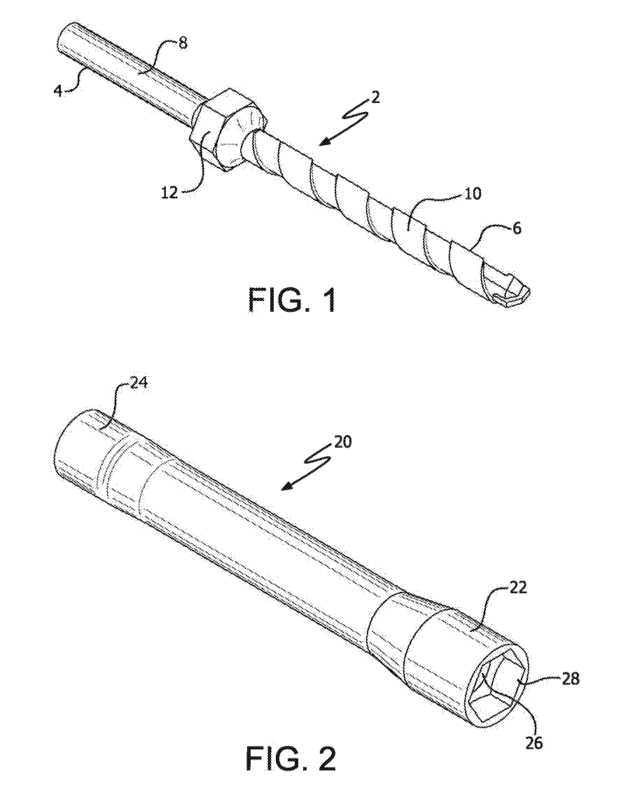

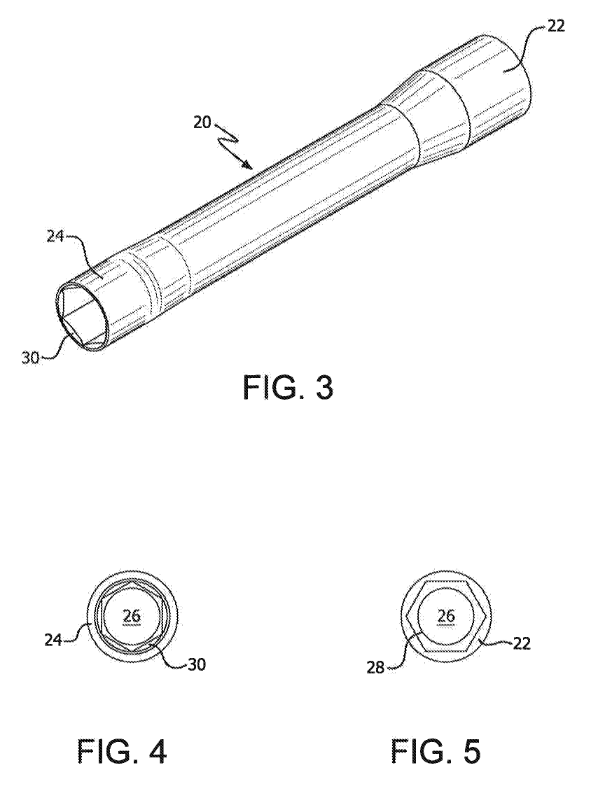

### DETAILED DESCRIPTION OF THE INVENTION

The wedge anchor setting tool of the present invention comprises elongated drill bit component 2 having front section 4 and rear section 6. Rear section 4 comprises drill bit receiving member 8 and front section 6 comprises drill bit member 10. Polygonal shaped element 12, shown in the drawings as being hexagonal in shape, is located between sections 4 and 6. Element 12 has a given width larger than the diameters of sections 4 and 6.

A separate and independent elongated sheath component 20 having first end 22 and second end 24, has open passage 26 extending therethrough, between the ends of the sheath component. Openings 28 and 30 at the terminus of ends 22 and 24, each have an internal width. First end 22 has a polygonal shape which conforms to the shape of polygonal element 12. Second end 24 has a polygonal shape which conforms to the shape of the wedge anchor 32 to be installed in a solid structure, such as masonry wall structure 40. Again, the drawings show these polygonal shapes as being hexagonal in nature. The internal width of opening 28 at first end 22 of sheath component 20 is slightly larger than the width of element 12 of drill bit component 2, such that the element can fit within end 22. The internal width of opening 30 at second end 24 is slightly larger than the corresponding shaped head of wedge anchor 32 being installed. The internal width of opening 28 at end 22 of sheath component 20 is greater than the width of opening 30 at end 24 of the sheath component.

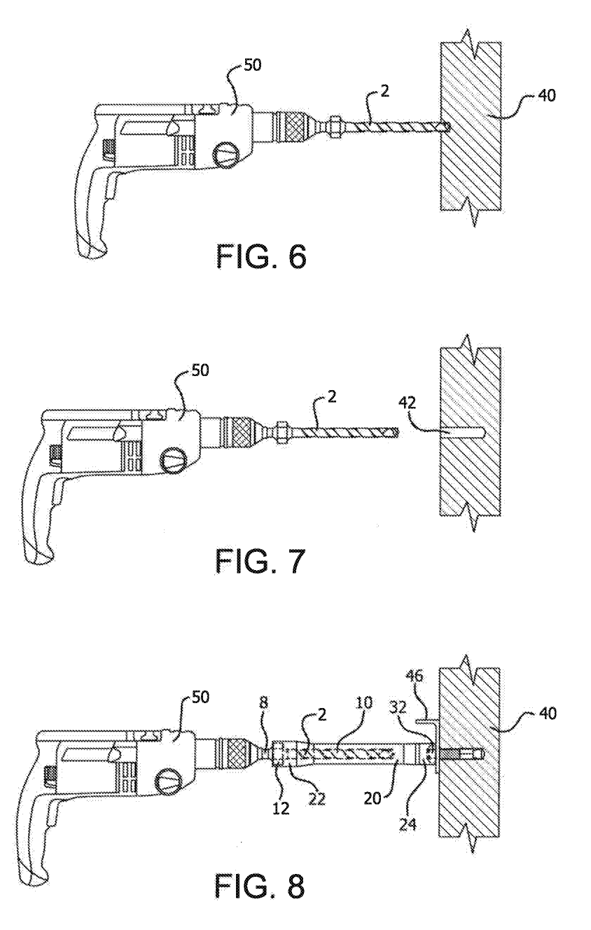

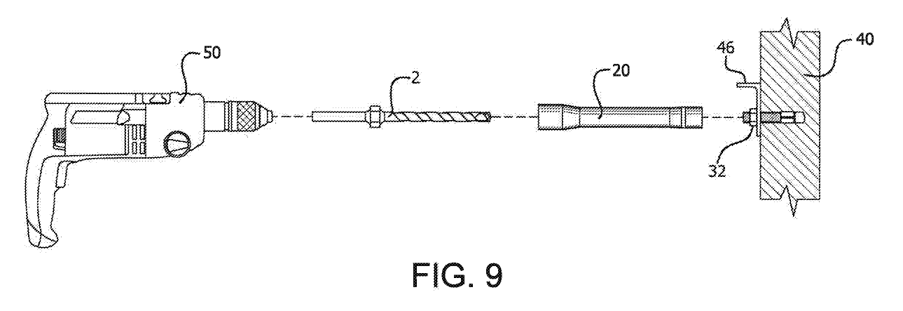

In operation, drill bit receiving member 8 of drill bit component 2 is connected to drilling tool 50. Drilling tool 50 is then operated to rotate drill bit component 2 such that channel opening 42 is drilled into wall structure 40. See FIGS. 6 and 7.

Drill bit component 2 is then withdrawn from channel opening 42. See FIG. 7. Sheath component 20 is then inserted over drill bit component 2 such that drill bit member 10 extends into passage 26 of the sheath component and polygonal shaped element 12 is fitted into end 22 of the sheath component. Drilling tool receiving member 8 extends out of sheath component 20. See FIG. 8. Wedge anchor 32 is inserted into opening 30 at end 24 of sheath component 20 to connect an attachment member, e.g. “L” shaped bracket 46. Bracket 46 is positioned between wall structure 40 and wedge anchor 32. Drill tool 50 is then operated to drive wedge anchor 32 into wall structure 40 and then to tighten the wedge anchor against bracket 46, utilizing the rotational force of the drill, to secure the bracket into the wall structure. Drilling tool 50, drill bit component 2, and sheath component 20 are then withdrawn from wall structure 40.

By use of the setting tool of the present invention, wedge anchors can be quickly and accurately installed into concrete, concrete block, and other masonry wall structures. The resulting installation provides an effective, secure, and accurate attachment of the wedge anchor.

While the drawings show that element 12 and the corresponding, conforming shape of end 22 of sheath component 20 are hexagonal in configuration, any convenient polygonal shape can be utilized for these components. In addition, drill bit components of a multitude of sizes can be provided for the installation of differently sized wedge anchors.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A wedge anchor setting tool for installation of wedge anchor into a solid structure, said setting tool comprising:
an elongated drill bit component having first and second sections, the drill bit component comprising a drilling tool receiving member at said first section, a drill bit member at said second section, and a polygonal shaped element having a given width located between the two sections; and
a separate and independent elongated sheath component having first and second ends, an open passage extending through the sheath component and between the ends, and an opening at the terminus of each end, each opening having an internal width, the first end having a polygonal shape which conforms to the shape of the polygonal element and the second end having a polygonal shape which conforms to the shape of the wedge anchor to be installed in the solid structure.

2. The wedge anchor setting tool as in claim 1 wherein the internal width of the opening at the first end is greater than the internal width of the polygonal shaped element and the internal width of the opening at the second end is greater than the shape of the wedge anchor being installed into the solid structure.

3. The wedge anchor setting tool as in claim 2 wherein the internal width of the opening at the first end is greater than the width of the opening at the second end.

4. The wedge anchor setting tool as in claim 1 wherein the polygonal shaped element and the first end are hexagonal in configuration.

5. The method for installing a wedge anchor into a solid structure to secure an attachment member comprising the steps of:
providing a drilling tool;
providing a drill bit component having first and second sections, the component comprising a drilling tool receiving member at said first section, a drill bit member at said second section, and a polygonal shaped element between the two end sections;
a separate and independent sheath component having first and second ends, an open passage extending through the sheath and between the ends, and an opening at the terminus of each end, the first end having a polygonal shape conforming to the shape of the polygonal element and the second end having a polygonal shape conforming to the shape of the wedge anchor to be installed;
connecting the drilling tool receiving member of the drill bit component to the drilling tool;
drilling a channel opening into a solid structure, utilizing the drilling tool and the drill bit member of the drill bit component;
withdrawing the drill bit component from the channel opening in the solid structure;
inserting the sheath component over the drill bit component such that the drill bit member extends into the passage of the sheath component, the polygonal shaped element is located in said first end of the sheath component, and the drilling tool receiving member extends out of the sheath component;
inserting a wedge anchor into the opening at the second end of the sheath component;
providing an attachment member to be secured to the solid structure;
positioning the attachment member between the wedge anchor and the solid structure;
driving the wedge anchor against the attachment member and into the solid structure; and
tightening the wedge anchor into the solid structure and against the attachment member, utilizing the rotational force of the drilling tool.
